(19) United States
(12) Patent Application Publication
(10) Pub. No.: US 2026/0261545 A1
(43) Pub. Date: Sep. 3, 2026

(54) INTELLIGENT WEBSOCKET BRIDGE-INTEGRATED SCANNER MANAGEMENT SYSTEM AND METHODS, INCLUDING EXAMPLES OF AI MODEL GENERATION AND TRAINING

(71) Applicant: CDK GLOBAL, LLC, Austin, TX (US)

(72) Inventor: Anup KUMAR, Portland, OR (US)

(21) Appl. No.: 19/067,725

(22) Filed: Feb. 28, 2025

(51) Int. Cl. H04L 9/40

(52) U.S. Cl. CPC H04L 63/029; H04L 63/08

(57) ABSTRACT

Systems and methods for integrating and remotely controlling network-connected scanners and generating and training AI models include generating, by a computing device communicatively coupled to one or more scanners via a network, and using a scanner-agnostic application programming interface (API), a tunnel connection between a cloud platform and the computing device via a WebSocket protocol; managing, by a socket control plane, the tunnel connection between the cloud platform, the computing device, and each of the one or more scanners using the WebSocket; and, remotely controlling, by the command control plane, each of the one or more scanners using the WebSocket and from the cloud platform. Systems and methods further include extracting information from scan data; and, generating and training an AI and/or ML model using the extracted information.

### TECHNICAL FIELD

The present disclosure relates generally to systems and methods for integrating and remotely controlling network-connected scanners and generating and training AI models. Examples of using WebSocket protocols and/or long polling protocols to securely connect network-connected scanners with a cloud platform are described. Examples of using a scanner-agnostic interface are also described. Examples of analyzing scan data, and generating and/or training an AI/ML model for further analysis and/or classification is further described.

### BACKGROUND

In enterprise environments, managing multiple scanners and large scanning jobs can be quite challenging due to the need for efficient coordination and prioritization. Administrators often face difficulties in queuing different jobs, ensuring that each scanner is utilized optimally without causing bottlenecks. Determining which scanning job to complete first requires careful consideration of factors such as job urgency, size, and complexity. High-priority tasks or those with tight deadlines should be prioritized, while larger, more time-consuming jobs might be scheduled during off-peak hours to minimize disruption. Implementing a robust job management system can help streamline this process, ensuring smooth and efficient operation.

Traditionally, most scanners available today (particularly those in enterprise settings where more than one scanner are collocated in the same environment) come with proprietary software developed by the manufacturer, which is typically designed for use as a standalone scanning solution. While this setup may suffice for basic scanning tasks, it is not ideal for scenarios that require industry-wide application or high-volume, bulk scanning needs. For such environments, a more scalable and efficient solution that minimizes manual intervention and integrates multiple scanners into a unified, centralized management system that is manufacturer and/or scanner agnostic, and that allows for remote control, management, and/or monitoring, would be immensely useful.

### BRIEF DESCRIPTION OF THE DRAWINGS

Reference is now made to the following descriptions taken in conjunction with the accompanying drawings, in which:

FIG. 1 is a schematic illustration of a system 100 for integrating and remotely controlling network-connected scanners and generating and training AI models, arranged in accordance with examples described herein;

FIG. 2 depicts a sample sequence diagram 200 for integrating and remotely controlling network-connected scanners and generating and training AI models, arranged in accordance with examples described herein;

FIG. 3 is a flowchart of method 300 for integrating and remotely controlling network-connected scanners, arranged in accordance with examples described herein;

FIG. 4 is a flowchart of method 400 for generating and training AI models, arranged in accordance with examples described herein; and,

FIG. 5 is a schematic illustration of a computing system 500, arranged in accordance with examples described herein.

### DETAILED DESCRIPTION

Certain details are set forth herein to provide an understanding of described embodiments of technology. However, other examples may be practiced without various of these particular details. In some instances, well-known computing system components, virtualization operations, and/or software operations have not been shown in detail in order to avoid unnecessarily obscuring the described embodiments. Other embodiments may be utilized, and other changes may be made, without departing from the spirit or scope of the subject matter presented herein.

Due in part to drawbacks of traditional systems described herein, it may be desirable to facilitate the integration and remote control of network-connected scanners in a scanner-agnostic way, as well as generate and/or train generative AI models using scan data that can be used to analyze and/or classify subsequent scan data.

Accordingly, systems and methods described herein provide a centralized platform that integrates multiple scanners using a WebSocket bridge, enabling fault-tolerant, scalable, connected, and efficient bulk scanning and AI-enhanced data processing. Unlike typical standalone scanner software, this solution allows for remote control, management, and monitoring of scanners from a single interface. It securely transfers scanned documents to the cloud, where AI algorithms create generative models for near real-time data analysis.

Systems and methods described herein further address traditional limitations as they integrate a WebSocket bridge to connect multiple scanners to a centralized control plane, enabling seamless remote control and management. The system and methods described herein may allow for bulk scanning operations across multiple scanners, reducing the need for manual handling. Through the centralized interface, users (e.g., administrative users, IT personnel, workforce individuals, managers, etc.) may remotely initiate and control the scanning process, manage scan settings, and monitor scanner status. Additionally, the system and methods described herein may facilitate the transfer of scanned images to a cloud-based platform, where the data may be processed using artificial intelligence (AI) to create a generative model, enabling near real-time consumption and analysis of the scanned data.

As one example, the systems and methods described herein may be particularly beneficial for industries that rely heavily on paper-based workflows, such as banking, car dealerships, financial institutions, and government agencies. The systems and methods described herein may enable these organizations to efficiently digitize and process large volumes of documents through an automated scanner management system, with minimal manual intervention and support for remote operations. The systems and methods described herein may streamline the data ingestion process, transforming traditional paper-based workflows into a scalable, cloud-based solution that is both intelligent and adaptive to changing business needs.

Advantageously, systems and methods described herein provide for numerous technical benefits over traditional systems that are limited in a number of ways. These advantages include, but are not limited to, secure communication, fault tolerance, remote control capabilities, AI-based generative modeling, manufacture independence (e.g., manufacture-agnostic), intelligent document detection, automated document grouping, and reduction of manual overload.

Advantageously, and with respect to secure communication, systems and methods discussed herein provide a platform that utilizes encrypted WebSocket connections to ensure secure data transmission between the scanners and the central control plane, safeguarding sensitive information during the scanning and data transfer processes.

Advantageously, and with respect to fault tolerance, systems and methods described herein are designed (and/or may be configured) with built-in fault detection capabilities, allowing them to automatically identify issues such as paper jams or scanner malfunctions. In some examples, the systems and methods described herein may pause operations and resume scanning once the fault is resolved, ensuring minimal disruption to the scanning workflow.

Advantageously, and with respect to remote control capabilities, systems and methods described herein provide for a centralized platform that may allow operators (e.g., users, administrator, IT personnel, etc.) to control scanners remotely, including initiating scans, adjusting settings, and managing the flow of scanned pages—all from a single interface, regardless of the scanner’s physical location.

Advantageously, and with respect to AI-based generative modeling, after the scanned pages are transferred to the cloud, the systems and methods described herein may leverage AI algorithms to create generative models from the data. This enables users (e.g., operators, administrator, IT personnel, etc.) to analyze and interact with the digitized information more effectively, facilitating insights and decision-making in near real-time.

Advantageously, and with respect to manufacture independence (e.g., manufacture-agnostic), systems and methods described herein are designed to be independent (e.g., agnostic) of any specific scanner manufacturer, allowing the systems and methods to integrate seamlessly with various brands and models. This flexibility ensures that users (e.g., operators, administrator, IT personnel, etc.) are not locked into a single vendor’s ecosystem and can adopt the solution in diverse environments (including enterprise environments, large environments, etc.).

Advantageously, and with respect to intelligent document detection, systems and methods described herein provide for AI-driven analysis within the platform that may automatically detect and classify different types of documents (e.g., from scan data), recognizing the nature and structure of each scanned page (e.g., scan data) for improved organization and processing.

Advantageously, and with respect to automated document grouping, systems and methods described herein includes capabilities for automatically grouping scanned documents of the same type, simplifying the organization and reducing the time required for manual sorting.

Advantageously, and with respect to reduction of manual overload, systems and methods described herein enable remote management and control of multiple scanners through a centralized interface. In examples, the system significantly reduces the manual effort typically associated with bulk scanning operations. This allows users to focus on higher-level tasks, improving overall productivity.

In this way, systems and methods described herein provide a comprehensive solution for bulk scanning needs, integrating secure, scalable, and intelligent technologies to optimize document digitization and processing workflows. By combining centralized management, AI capabilities, and seamless cloud integration, systems and methods described herein provide for a robust tool for industries that require high-volume scanning and real-time data access.

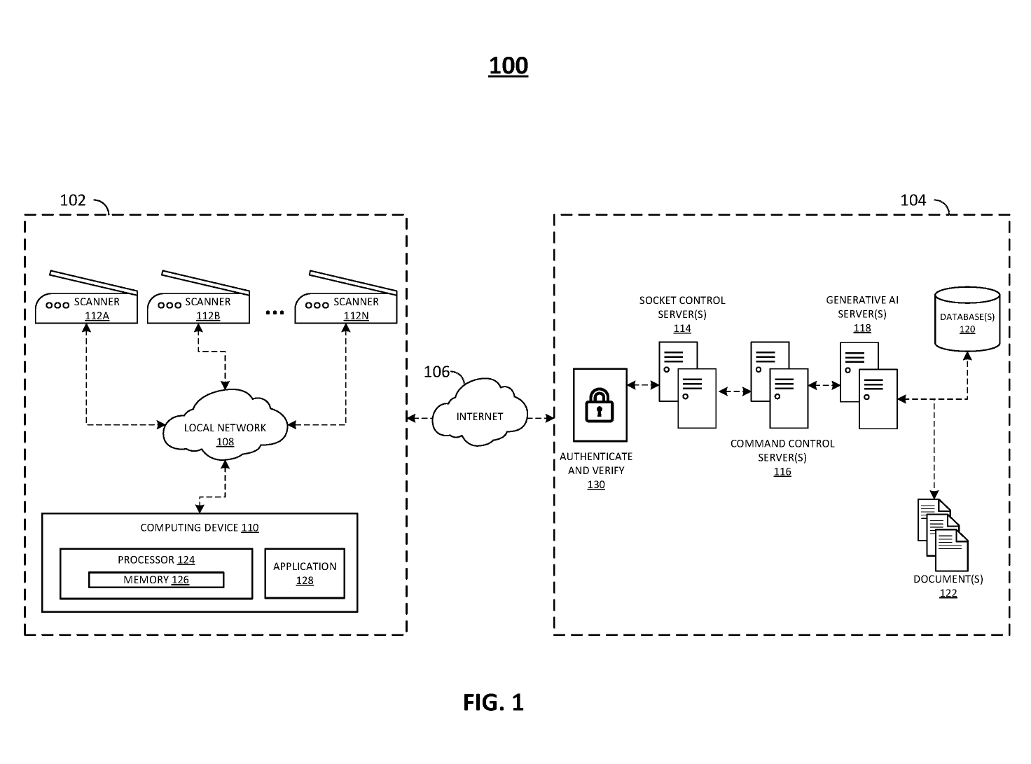

Turning now to FIG. 1, FIG. 1 is a schematic illustration of a system 100 for integrating and remotely controlling network-connected scanners, and generating and training AI models, arranged in accordance with examples described herein.

System 100 of FIG. 1 may include enterprise system 102, cloud platform 104, and Internet 106. Enterprise system 102 may include one or more scanners, such as scanner 112A, 112B, and/or 112N(collectively described herein as scanners 112A-112N), local network 108, and computing device 110. Computing device 110 may include processor 124 and application 128. Processor 124 may include memory 126. Cloud platform 104 may include socket control servers 114, command control servers 116, generative AI servers 118, databases 120, and documents 122. Socket control servers 114 of cloud platform 104 may utilize authenticate and verify 130 to authenticate and/or verify a tunnel communication connection from enterprise system 102 as described herein.

It should be appreciated that components shown in FIG. 1 are examples. It should be understood that additional, fewer, and/or alternative components may be used in other examples. Generally, components shown and described with reference to FIG. 1, which perform transmitting, processing, calculating, analyzing, classifying, receiving, and/or other data manipulations, may be understood to be implemented in hardware, software, or combinations thereof.

For example, computing device 110 may be implemented using one or more processors and memory encoded with executable instructions for performing one or more of their functions (e.g., software) described herein, such as processor 124 and/or memory 126. In some examples, one or more of the other components of enterprise system 102 and/or cloud platform 104 may be implemented using one or more processors and memory encoded with executable instructions for performing their functions described herein. In some examples, one or more application specific integrated circuits (ASICs), field programmable gate arrays (FPGAs), systems on a chip (SOCs), or other logic may be used. Any electronic, local, cloud, pooled, and/or shared storage may be used to store information (e.g., policies, metrics, scan data, subsequent scan data, extracted data, analyzed data, AI and/or ML models, outputs and/or inferences from AI and/or ML models, etc.) described herein, such as any kind of memory.

Examples described herein may accordingly include one or more enterprise systems, such as enterprise system 102. As used herein, an enterprise system may represent any number of environments. In some examples, enterprise system 102 may comprise a modern office environment in which a variety of computing devices work together to support business objectives. In some examples, enterprise system 102 may comprise an environment that includes desktop computers, laptops, scanners, printers, fax machines, and network servers, all interconnected through a robust network infrastructure. In some examples, administrators and/or IT personnel may manage one or more devices within enterprise system 102 to ensure smooth operation. In some examples, employees may use one or more devices within enterprise system 102 to perform daily tasks such as document creation, data entry, communication, information sharing, scanning functions, faxing functions, data processing, workflow managing, file management, customer relation management, or the like. In such environments, such as enterprise system 102, the integration of these devices may enhance productivity, streamline workflows, and facilitate efficient collaboration across different departments. Computing devices included in such enterprise systems may have access to one or more other computing devices within the enterprise system. Computing devise in such enterprise system may further have access to one or more cloud platforms.

Examples of enterprise systems described herein may include one or more scanners, such as scanners 112A-112N. Examples of scanners, such as scanners 112A-112N, may include one or more devices that are configured to capture images from physical documents, photos, or other objects and convert them into digital format (e.g., JPEG, PDF, TIFF, etc.). In some examples, this allows users to store, edit, and share the scanned content electronically. Examples of scanners described herein may include one or more flatbed scanners, sheet-fed scanners, handheld scanners, and the like. In some examples, scanners 112A-112Nmay be configured to perform on or more operations and/or functions, such as scanning text documents for digital archiving, converting printed photos into digital images, and/or using Optical Character Recognition (OCR) technology to transform printed text into editable digital text.

It should be appreciated that while scanners 112A-112Nare discussed herein as being configured to be remotely controlled and/or managed by one or more components of a cloud platform (such as cloud platform 104), any number of other computing devices typically found in enterprise systems (e.g., fax machines, etc.) may be configured to be remotely controlled and/or managed using the systems and methods described herein, and is contemplated to be within the scope of this disclosure. It should further be appreciated that while one or more scanners, such as scanners 112A-112N, are depicted in system 100 of FIG. 1, additional, fewer, and/or alternative scanners are contemplated as being within the scope of this disclosure. It should also be appreciated that while one or more scanners, such as scanners 112A-112N, are depicted in system 100 of FIG. 1, additional and/or alternative computing devices capable of performing one or more functions similar to, or different from, that of a scanner is contemplated to be within the scope of this disclosure.

Examples described herein may include one or more networks, such as local network 108. Computing device 110 may be communicatively coupled to scanners 112A-112N via local network 108. In some examples, local network 108 may comprise a local Area Network (LAN) to connect computing device 110 to scanners 112A-112N. In some examples, local network 108 may comprise a wide Area Networks (WAN). In some examples, local network 108 may comprise one or more wired and/or wireless network protocols, including but not limited to ethernet, Wi-Fi, Bluetooth, etc. which provide for flexible connectivity. In some examples, local network 108 may comprise a virtual private network (VPN) to offer additional security and remote access. In some examples, local network 108 may provide for the exchange of data between scanners 112A-112N, computing device 110, and/or any additional and/or alternative components (not shown) in enterprise system 102. In some examples, a same network may be used to communicate between the computing device 110 and cloud platform 104. In some examples, multiple networks may be used. In some examples, one or more different networks may be used.

Examples described herein may include one or more computing devices, such as computing device 110. In some examples, computing device 110 may be implemented using one or more computers, servers, smart phones, smart devices, or tablets. Computing device 110 may facilitate the remote integration and control of network-connected scanners and/or the generating and training of (generative) AI models. As described herein, computing device 110 includes processor 124 and memory 126. While not shown, memory 126 includes executable instructions for integrating and remotely controlling network-connected scanners and/or executable instructions for generating and/or training AI models. In some embodiments, computing device 110 may be physically coupled to one or more of scanners 112A-112N. In other embodiments, computing device 110 may not be physically coupled scanners 112A-112N, but collocated with one or more of scanners 112A-112N. In even further embodiments, computing device 110 may neither be physically coupled to one or more of scanners 112A-112N nor collocated with one or more of scanners 112A-112N.

Computing devices, such as computing device 110 described herein may include one or more processors, such as processor 124. Any kind and/or number of processor may be present, including one or more central processing unit(s) (CPUs), graphics processing units (GPUs), other computer processors, mobile processors, digital signal processors (DSPs), microprocessors, computer chips, and/or processing units configured to execute machine-language instructions and process data, such as executable instructions for integrating and remotely controlling network-connected scanners and/or executable instructions for generating and/or training AI models.

Computing devices, such as computing device 110 described herein may further include memory 126. Any type or kind of memory may be present (e.g., read-only memory (ROM), random access memory (RAM), solid state drive (SSD), and secure digital card (SD card)). While a single box is depicted as memory 126, any number of memory devices may be present. The memory 126 may be in communication (e.g., electrically connected, communicatively coupled, etc.) to processor 124.

Memory 126 may store executable instructions for execution by the processor 124, such as executable instructions for integrating and remotely controlling network-connected scanners and/or executable instructions for generating and/or training AI models. In some examples, computing device 110 may execute instructions stored in memory 126 by processor 124 to utilize application 128 to generate a tunnel connection, via a WebSocket over Internet 106, to cloud platform 104.

Computing devices, such as computing device 110 described herein, may further include application 128. Application 128 may be used by computing device 110 to generate the tunnel connection between enterprise system 102 and cloud platform 104. In some examples, application 128 may comprise a be a scanner-agnostic application programming interface (API). In some examples, application 128 may comprise a TWAIN driver interface. In some examples, computing device 204 may generate the tunnel connection via application 128 utilizing a WebSocket (e.g., one or more WebSocket protocols). In some examples, computing device 204 may generate the tunnel connection via application 128 utilizing one or more other protocols, such as long polling protocols. In some examples, the software component and/or application may already be installed on computing device 110. In some examples, the application and/or software component may be installed on computing device 110 from, for example, a third party, a user, an administrator, an enterprise administrator, IT personnel, or the like.

In some examples, one or more components of computing device 110, including but not limited to application 128, may provide for one or more APIs and/or other interfaces and/or other drivers that enable computing device 110 and/or scanners 112A-112N to interact with wireless hardware or network protocols, facilitating data exchange (e.g., exchange of scan data) and control (e.g., remote control, management, and/or monitoring of scanners 112A-112N) as described herein.

Examples described herein may include a cloud platform, such as cloud platform 104. Cloud platform 104 may be any number of web and/or cloud platforms that may be configured to host one or more planes and/or servers, each capable of performing one or more functions, such as data processing, data extraction, artificial intelligence/machine learning (AI/ML) model generation, AI/ML model training, tunnel connection monitoring, scanner health monitoring, scanner job monitoring, operational and/or functional control of one or more scanners, health alert generation functionality, scanner initialization functionality, and/or authentication and access functionality. As described herein, cloud platform 104 may be configured to perform one or more of these functions and/or operations via a tunnel communication between enterprise system 102 and cloud platform 104. The tunnel communication may be generated by computing device 110 via one or more WebSocket protocols (and/or other protocols as discussed herein). The tunnel communication may be generated by computing device 110 and may be maintained (e.g., managed, secured, etc.) by one or more components of cloud platform 104, such as by socket control servers 114.

Cloud platform 104 may communicate with one or more systems, such as enterprise system 102, using one or more networks, such as Internet 106. In some examples, Internet 106 may comprise a wide Area Networks (WAN). In some examples, Internet 106 may comprise one or more wired and/or wireless network protocols, including but not limited to ethernet, Wi-Fi, Bluetooth, etc. which provide for flexible connectivity. In some examples, Internet 106 may comprise a virtual private network (VPN) to offer additional security and remote access. In some examples, Internet 106 may provide for the exchange of data between scanners 112A-112N, computing device 110, and/or any additional and/or alternative components (not shown) in enterprise system 102, and cloud computing platform 104. In some examples, the WebSocket used to generate the tunnel connection (e.g., to transmit scan data, scanner metrics, and the like from enterprise system 102 to cloud platform 104) may be hosted on a network, such as Internet 106.

Cloud platform 104 may include socket control servers 114, command control servers 116, generative AI servers 118, and databases 120.

Examples of cloud platform 104 described herein may include one or more socket control servers (e.g., socket control plane), such as socket control servers 114. Socket control servers 114 may be comprised of one or more servers and/or modules, and may be configured to manage a continuous and secure connection between one or more of scanners 112A-112N and cloud platform 104. In some examples, socket control servers 114 may manage the continuous and secure connection through one or more protocols, such as one or more WebSocket and/or polling long polling protocols. In some examples, socket control servers 114 may be configured to maintain the tunnel connection as a bidirectional tunnel, and may further be configured to regularly perform health checks using, for example, a ping-pong technique that may ensure the tunnel connection remains active and stable. Socket control plane 114 may be configured to further be responsible for authenticating the tunnel connection and/or for maintaining robust security throughout the communication process (e.g., communications between one or more components of enterprise system 102 and one or more components of cloud platform 104 and/or one or more additional and/or alternative components of system 100 not shown). In some examples, socket control servers 114 may use authenticate and verify 130 to perform part or all of the authentication, permissions, access, and verification processes to ensure the tunnel connection remains active, stable, and/or secure.

Examples of cloud platform 104 described herein may include one or more command control servers (e.g., command control plane), such as command control servers 116. Examples of command control servers 116 may be configured to (through the socket control plane 116 in some examples) send and/or transmit one or more directives to one or more of scanners 112A-112N of enterprise system 102. In some examples, command control servers 116 may be configured to perform remote initiation on the one or more scanners 112A-112N using the directives and via the WebSocket. In some examples, command control servers 116 may be configured to remotely configure one or more of scanners 112A-112N using the directives and via the WebSocket. In some examples, command control servers 116 may be configured to remotely manage one or more scanning sessions (and or other scanner-related functionality) of one or more of scanners 112A-112N using the directives and via the WebSocket. In some examples, command control servers 116 may apply predefined rules to ensure that incoming commands are queued or rejected based on one or more policies (e.g., factors), including but not limited to a scanner load policy, a network capacity policy, and/or a workflow priorities policy. In some examples, command control servers 116 may allow for dynamic allocation of scanning tasks, directing requests to the next available scanner when required, thus optimizing large-scale scanning operations and reducing bottlenecks.

In some examples, command control servers 116 may receive scan data from computing device 110. In some examples, command control servers 116 may extract information from the scan data and store the extracted information in one or more databases, such as databases 120. In some examples, the extracted information stored in one or more databases, such as databases 120 may be utilized by a generative AI plane (such as generative AI servers 118) for AI/ML model generation and/or training for use in analyzing other and/or subsequently received scan data (and/or other relevant information).

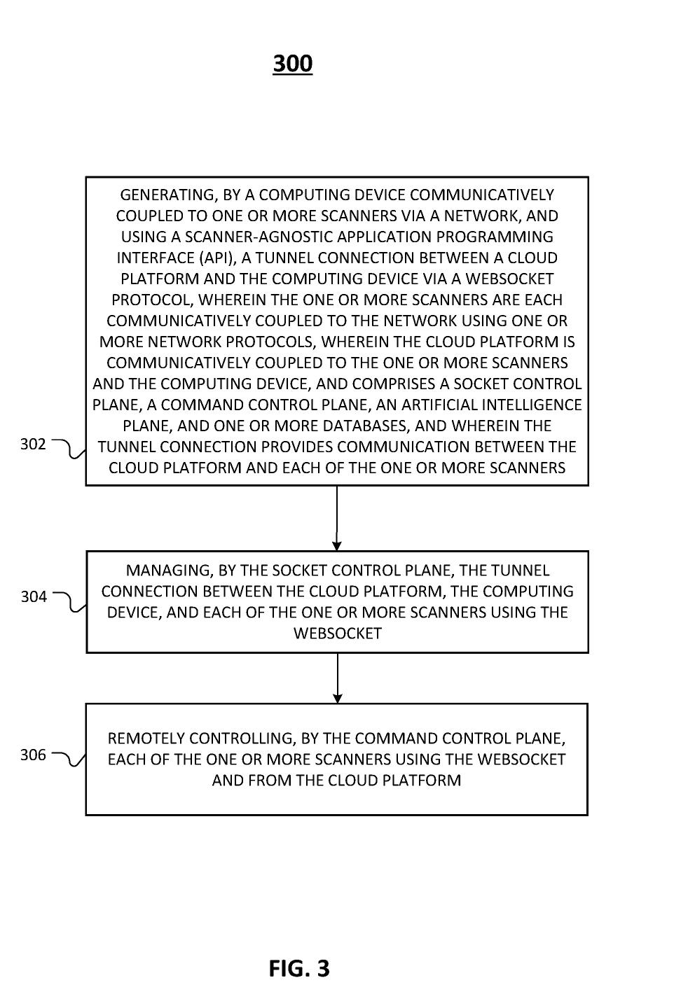

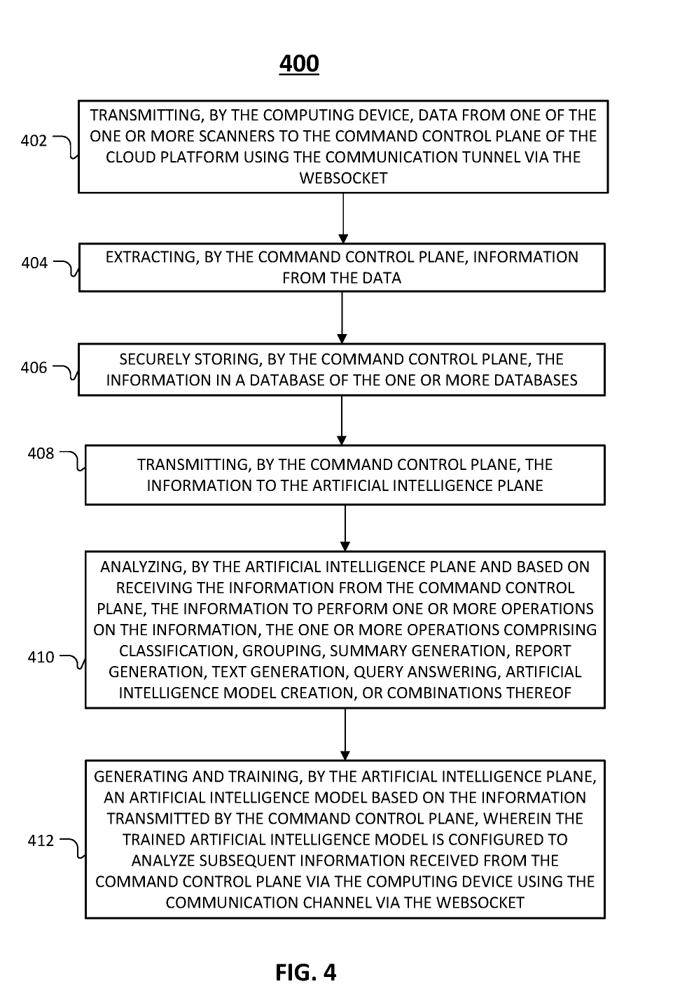

Examples of cloud platform 104 described herein may include one or more generative AI servers, such as generative AI servers 118. Examples of generative AI servers 118 as described herein may be configured to perform operations of the extracted information from the scan data stored in the cloud storage and/or one or more databases, such as databases 120. In some examples, generative AI servers 118 may be configured to perform AI-based extraction of the scan data, extracting the data into further text, layouts, and/or structured tables. In some examples, generative AI servers 118 may be further configured to perform one or more advanced processing operations on the extracted scan data. In some examples, generative AI servers 118 may be configured to perform an auto-classification of documents operation in which generative AI servers 118 may automatically categorize documents based on content. Generative AI servers 118 may be further configured to perform an auto-grouping operation, in which generative AI servers 118 groups similar documents for more efficient handling. Generative AI servers 118 may be further configured to create and/or generate one or more custom AI models, as further described herein, such as in method 300 of FIG. 3 and method 400 of FIG. 4.

Examples described herein may include one or more databases and/or storage locations and/or datastores, such as databases 120 (e.g., a datastore, etc.). Databases 120 may generally be and/or include any form of memory and/or storage, such as a solid state drive (SSD), hard disk drive (HDD), Non-Volatile Memory Express (NVMe) drive, and the like, configured to store data and/or metadata, such as scanner metrics, scan data, subsequent scan data, extracted information from scan data, generated ML and/or AI models, trained ML and/or AI models, data used to train and/or generate ML and/or AI models, and/or any additional and/or alternative data and/or metadata relevant to integrating and remotely controlling network-connected scanners and/or training/generating AI/ML models, and/or performing any other operations relevant to system 100. In some examples, databases 120 may include data and/or metadata received from scanners 112A-112N, such as respective scanner metrics from one or more of scanners 112A-112N. In some examples, databases 120 may include data and/or metadata received from computing device 110. In some examples, databases 120 may include data and/or metadata received from any one of components socket control servers 114, command control servers 116, and/or generative AI servers 118. In some examples, databases 120 may include data and/or metadata relating to documents 122, and/or authenticate and verify 130. In some examples, databases 120 may receive such information (e.g., data and/or metadata) via one or more interfaces and/or tunnel connections, including a TWAIN driver interface of application 128 of computing device 110 and via one or more WebSocket protocols.

Operationally, and as described in further detail herein at least at sequence diagram 200, method 300, and/or method 400, computing device 110 that is to be communicatively coupled to one or more of scanners 112A-112N may generate a tunnel connection between cloud platform 104 and computing device 110 using one or more WebSocket protocols via Internet 106 and using a scanner-agnostic application programming interface (API) (application 128). Socket control servers 114 may be configured to manage the tunnel connection between cloud platform 104, computing device 110, and each of the one or more scanners 112A-112N using the WebSocket. Command control servers 116 may be configured to remotely control each of the one or more scanners 112A-112N using the WebSocket and from the cloud platform 104.

Operationally, and as described in further detail herein at least at sequence diagram 200, method 300, and/or method 400, computing device 110 may be configured to transmit data (e.g., scan data) from one of the one or more scanners 112A-112N to command control servers 116 of cloud platform 104 using the communication tunnel via the WebSocket. Command control servers 116 may be further configured to extract information from the data (e.g., the scan data). Command control servers 116 may be further configured to securely store the information from the data in database 120. Command control servers 116 may be further configured to transmit the information to generative AI servers 118. Generative AI servers 118 may be configured to analyze the information and/or perform one or more operations on the information. In some examples, the one or more operations comprise and/or include one or more of classification, grouping, summary generation, report generation, text generation, query answering, artificial intelligence model creation, or combinations thereof. Generative AI servers 118 may be configured to generate and train an artificial intelligence and/or a machine learning model based on the information transmitted by command control servers 116. In some examples, the trained artificial intelligence and/or machine learning model (via one or more components on cloud platform 104, such as via generative AI servers 118) may be configured to analyze subsequent information received from command control servers 116 via computing device 110 using the communication channel via the WebSocket.

In this way, systems and methods described herein provide for the integration and remote control of scanners (e.g., network-connected scanners) and/or other applicable network-connected computing devices. In this way, systems and methods described herein further provide for the generating and training of AI/ML models for use in the analysis of scan data. Advantageously, and as discussed herein, system and methods described herein provide a centralized platform that integrates multiple scanners using a WebSocket bridge, enabling fault-tolerant, scalable, connected, and efficient bulk scanning and AI-enhanced data processing, overcoming limitations, including technical limitations, of traditional systems.

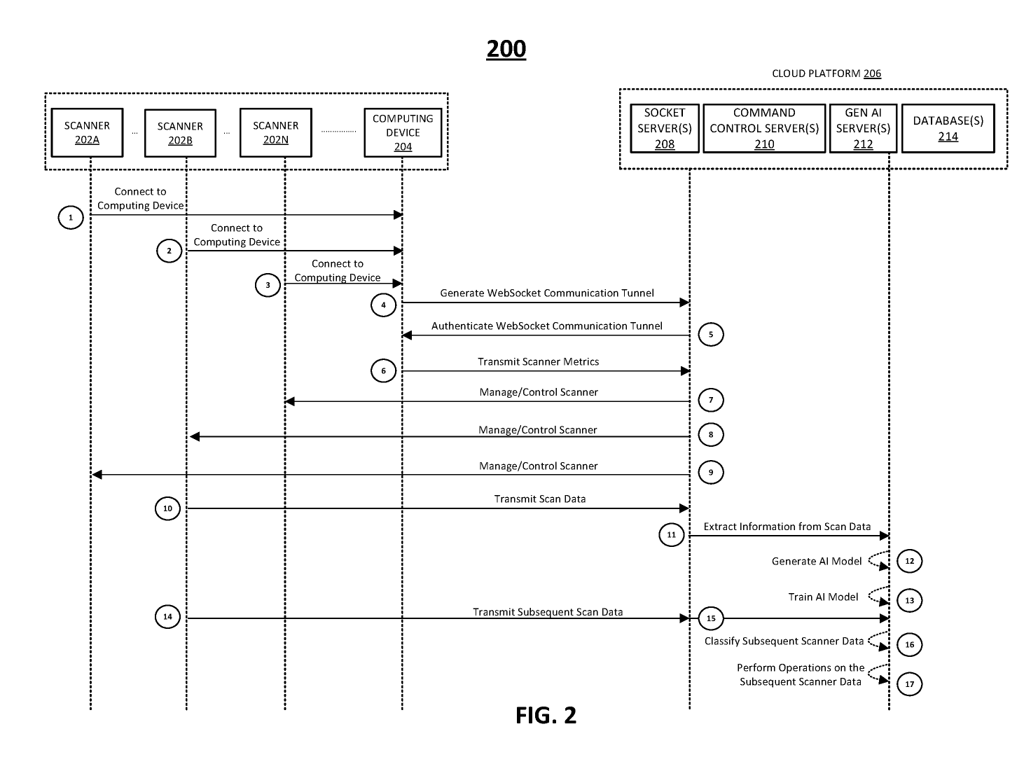

Turning now to FIG. 2, FIG. 2 depicts a sample sequence diagram 200 for integrating and remotely controlling network-connected scanners and generating and training AI models, arranged in accordance with examples described herein.

Sequence diagram 200 includes scanners 202A-202N, computing device 204, and cloud platform 206. In some examples, scanners 202A-202N and computing device 204 may be colocated. In some examples, one or more of scanners 202A-202N may not be collocated with one or more of the other scanners 202A-202N. In some examples, scanners 202A-202N may not be collected with computing device 204. In sequence diagram 200, scanners 202A-202N are communicately coupled (e.g., network connected) to computing device 204. While not shown, scanners 202A-202N and computing device 204 may be part of an enterprise system, such as enterprise system 102 of FIG. 1. Cloud platform 206 of sequence diagram 200 includes socket servers 208, command control servers 210, generative AI servers 212, and databases 214.

Scanners 202A-202N may be configured to perform one or more functions described herein, including one or more functions of scanners 112A-112N of FIG. 1. Computing device 204 may be configured to perform one or more functions described herein, including one or more functions of computing device 110 of FIG. 1. Similarly, scanners 112A-112N of FIG. 1 may be configured to perform one or more of the operations performed by scanners 202A-202N of sequence diagram 200. Further, computing device 110 of FIG. 1 may be configured to perform one or more of the operations performed by computing device 204 of sequence diagram 200.

Cloud platform 206, socket servers 208, command control servers 210, generative AI servers 212, and databases 214 may be confirmed to perform one or more respective functions of cloud platform 104, socket control servers 114, command control servers 116, generative AI servers 118, and databases 120 of FIG. 1, respectively. Similarly, socket control servers 114, command control servers 116, generative AI servers 118, and databases 120 of FIG. 1 may each be configured to perform one or more operations of cloud platform 104, socket servers 208, command control servers 210, generative AI servers 212, and databases 214 of FIG. 2.

Sequence diagram 200 includes 17 steps. At step 1, scanner 202A connects to computing device 204. At step 2, scanner 202B connects to computing device 204. At step 3, scanner 202N connects to computing device 204. As described herein, each of scanners 202A-202N may be configured to connect with computing device 204 via a network, such as local network 108 of FIG. 1. In some examples, scanners 202A-202N may be network-connected scanners. In some examples, the network connection between each of the one or more scanners 202A-202N and computing device 204 may be facilitated using one or more internal operating system (OS) mechanisms of devices like those running on MAC or Windows operating systems. In some examples, the networked connection between each of the one or more scanners 202A-202N and computing device 204 may be facilitated using one or more networking protocols as described herein. In some examples, while not shown in sequence diagram 200, when connecting to computing device 204, one or more of scanners 202A-202N may be configured to provide computing device 204 with one or more metrics, such as scanner capability information and/or scanner operational information.

At step 4, computing device 204 generates a tunnel connection between itself and cloud platform 206. As described herein, in some examples, computing device 204 may be configured to generate the tunnel connection using one or more protocols and/or one or more driver interfaces, such as a WebSocket protocol. In some examples, and while not shown in sequence diagram 200, computing device 204 may be configured to generate the tunnel connection using a software component and/or an application, such as application 128 of FIG. 1. In some examples, while not shown, the application used by computing device to generate the tunnel connection may be a scanner-agnostic API and/or a TWAIN driver interface. In some examples, computing device 204 may generate the tunnel connection via one or more other protocols, such as long polling protocols.

At step 5, socket server 208 of cloud platform 206 may authenticate the tunnel connection generated between itself and computing device 204 via the WebSocket. In some examples, socket servers 208 may authenticate the tunnel connection using one or more authentication and/or verification methods and/or policies, such as authenticate and verify 130 of FIG. 1. In some examples, socket servers 208 may authenticate the tunnel connection using a key. In some examples, socket servers 208 may authenticate the tunnel connection using one or more other suitable cryptographic techniques. In some examples, socket server 208 of cloud platform 206 may maintain the security of the tunnel connection generated between computing device 204 and cloud platform 206 via the WebSocket. In some examples, the generated tunnel connection is a secure, bidirectional tunnel connection.

At step 6, computing device 204 transmits scanner metrics for one or more of scanners 202A-202N to socket servers 208 of cloud platform 206. As described herein, the one or more metrics may be used by socket servers 208 of cloud platform 206 to (remotely) control, manage, initialize, monitor, update, and/or repair one or more of scanners 202A-202N.

At step 7, socket servers 208 manages and/or controls scanner 202A. At step 8, socket servers 208 manages and/or controls scanner 202B. At step 9 socket servers 208 manages and/or controls scanner 202N. In some examples, socket servers 208 manage and/or controls scanners 202A-202N by sending (e.g., transmitting, communicating, etc.) one or more directives to one or more of scanners 202A-202N. In some examples, these directives may enable remote initiation of one or more of scanners 202A-202N. In some examples, these directives may enable remote configuration of one or more of scanners 202A-202N. In some examples, these directives may enable remote management for one or more scanning sessions (or other scanner functionality) of one or more of scanners 202A-202N.

At step 10, scanner 202B, via computing device 204 and using the WebSocket connection, transmits scan data to socket servers 208 of cloud platform 206. As described herein, the scan data may include, but is not limited to, text data, image data, color data, layout data, metadata, and other applicable data associated with one or more functions of a scanner, such as scanner 202B.

At step 11, command control servers 210 of cloud platform 206 extracts the one or more of the data included in the scan data from scanner 202B transmitted by computing device 204. In some examples, command control servers 210 is configured to extract the data (e.g., information) from the scan data via one or more processes, such as a pre-processing step, a text recognition step, a data structuring step, and/or a post-processing step. Command control servers 210 may be configured to store the data in one or more local and/or cloud storage locations, such as databases 214 of FIG. 2.

At step 12, generative AI servers 212 generates an AI model. As discussed herein, generate AI servers 212 may be configured to perform one or more operations on the information extracted from the scan data, the one or more operations comprising classification, grouping, summary generation, report generation, text generation, query answering, artificial intelligence model creation, or combinations thereof. Generative AI servers 212 may further be configured to, using that information (e.g., data), generate an AI and/or ML model, such as a generative AI model.

At step 13, generative AI servers 212 trains the AI and/or ML model generated using the information extracted from the scan data. At step 14, scanner 202B sends subsequent scan data to computing device 204. At step 15, computing device 204 sends subsequent scan data to socket server 208 of cloud platform 206 and via the WebSocket connection.

At step 16, generative AI server 212 analyzes the subsequent scan data received from computing device 204, and using the generated and trained AI and/or ML model, classifies the information comprising the subsequent scan data. At step 17, generative AI server 212 may analyze the subsequently received scan data and perform one or more operations on it, including but not limited to auto-classification (e.g., assigning a type ID to the data) and/or auto-grouping, and/or other applicable operations.

The sequence diagram 200 of FIG. 2 is exemplary, and it should be appreciated that one or more additional and/or alternative implementations described herein may be utilized to perform the operations described herein, without departing from the scope of this disclosure.

Turning now to FIG. 3., FIG. 3 is a flowchart of method 300 for integrating and remotely controlling network-connected scanners, arranged in accordance with examples described herein.

The method 300 includes generating, by a computing device communicatively coupled to one or more scanners via a network and using a scanner-agnostic application programming interface (API), a tunnel connection between a cloud platform and the computing device via a WebSocket protocol in block 302, managing, by a socket control plane, the tunnel connection between the cloud platform, the computing device, and each of the one or more scanners using the WebSocket in block 304, and, remotely controlling, by a command control plane, each of the one or more scanners using the WebSocket and from the cloud platform in block 306.

Block 302 recites generating, by a computing device communicatively coupled to one or more scanners via a network, and using a scanner-agnostic application programming interface (API), a tunnel connection between a cloud platform and the computing device via a WebSocket protocol. Block 302 further recites that the one or more scanners are each communicatively coupled to the network using one or more network protocols. Block 302 further recites that the cloud platform is communicatively coupled to the one or more scanners and the computing device, and comprises a socket control plane, a command control plane, an artificial intelligence plane, and one or more databases. Block 302 further recites that the tunnel connection provides communication between the cloud platform and each of the one or more scanners.

In some examples, each of the one or more scanners, such as such as scanner 112A, 112B, and/or 112N, respectively, of FIG. 1, may be connected to and/or communicatively coupled to the computing device, such as computing device 110 of FIG. 1, via a network, such local network 108 of FIG. 1. In some examples, the network connection connecting the one or more scanners 112A-112N to the computing device 110 may be facilitated using one or more internal operating system (OS) mechanisms of devices like those running on MAC or Windows operating systems. In some examples, the networked connection between each of the one or more scanners 112A-112N and computing device 110 may be facilitated using one or more networking protocols.

In some examples, computing device 110 may include and/or comprise a software component and/or application, such as application 128. Such software component and/or application may be configured to and/or capable of running one or more communications protocols and/or driver interfaces. In some examples, such software component and/or application may be configured to run a scanner-agnostic application programming interface (API). In some examples, such software component and/or application may be configured to run a TWAIN driver interface. In some examples, the scanner-agnostic API may be a TWAIN driver interface. In some examples, computing device 110 may be configured to generate the tunnel connection to a cloud platform, such as cloud platform 104 via the scanner-agnostic API (e.g., a TWAIN driver interface) using application 128. In some examples, the software component and/or application may already be installed on computing device 110. In some examples, the application and/or software component may be installed on computing device 110 from, for example, a third party, a user, an administrator, an enterprise administrator, IT personnel, or the like.

In some examples, the tunnel generated between cloud platform 104 and computing device 110 via a WebSocket (e.g., WebSocket protocols) may be facilitated by any number of communication techniques, such as Internet 106 (e.g., via a 5G, 4G LTE, Wi-Fi, etc. network environment). In some examples, when streaming capabilities are limited, one or more components of system 100 (e.g., computing device 110 and/or the cloud platform 104, and/or one or more other components) may switch to a more available and/or more stable connection, such one or more long polling techniques, in order to maintain connectivity. In some examples, the tunnel generated between cloud platform 104 and computing device 110 via a WebSocket (e.g., WebSocket protocols) may be a secure, bidirectional communication tunnel. The secure, bidirectional channel provides, in some examples, a protected channel that allows data to flow in both directions between two endpoints (e.g., computing device 110 and cloud platform 104). This type of tunnel ensures that the communication (e.g., scanner data sent between enterprise system 102, computing device 110, and/or scanners 112A-112N, and cloud platform 104) is encrypted and secure, preventing unauthorized access.

As used herein, computing device 110 may include any electronic apparatus and/or device capable of processing data and/or executing instructions to perform tasks. In some examples, computing device 110 may be any number of computing devices, including but not limited to, one or more personal computers (PC) and/or a Raspberry Pi board. In some examples, computing device 110 may be a mobile device, such as a smartphone or tablet, which are portable and integrate computing capabilities with communication functions. In some examples, computing device 110 may be one or more laptops, which combine the functionality of a PC with portability. In some examples, computing device 110 may be one or more servers, which provide resources and services to other computers over a network. In some examples, computing device 110 may be one or more embedded systems, which are specialized computing systems integrated into larger devices to control specific functions.

In some examples, a computing device such as computing device 110 of FIG. 1 is further configured to, using the tunnel connection via the WebSocket, transmit metrics for at least one of the one or more scanners, such as scanners 112A-112N to the cloud platform, such as cloud platform 104 of FIG. 1. In some examples, the metrics may comprise scanner capability information. In some examples, the metrics may comprise scanner operational information. In some examples, the metrics may comprise a combination of scanner capability information and/or scanner operational information. In some examples, the metrics may enable and/or provide for the remote control of at least one scanner, such as scanner 112A, 112B, and/or 112N, respectively, by the cloud platform.

In some examples, a computing device such as a computing device 110 of FIG. 1 is further configured to generate the tunnel connection between the cloud platform, such as cloud platform 104, and the computing device, such as computing device 110, via a long polling protocol. In some examples, computing device 110 may generate the tunnel connection using a scanner-agnostic API, such as application 128 of FIG. 1. It should be appreciated that while use of a WebSocket and/or a long polling protocol is discussed herein for generating the tunnel connection between cloud platform 104 and computing device 110, other methods and/or protocols suitable for generating such connection are contemplated to be within the scope of this disclosure.

In some examples, computing device 110 may be further configured to transmit one or more capabilities of one or more of scanners 112A-112N to cloud platform 104 via the tunnel connection generated, e.g., via the WebSocket and over a network connection, such as Internet 106. In some examples, computing device 110 may be further configured to ensure a secure data exchange between computing device 110 and cloud platform 104. In some examples, computing device 110 may ensure the secure data exchange using secure sockets layer (SSL) encryption which provides for one or more of privacy, authentication, and integrity to internet communications. In some examples, computing device 110 may be further configured to perform dual handshake authentication between the computing device 110 and the cloud platform 104, via the WebSocket. In some examples, computing device 110 may be further configured to perform certificate verification between computing device 110 and cloud platform 104. In some examples, the certificate verification prevents spoofing or unauthorized access to, e.g., computing device 110, any of scanners 112A-112N, and/or cloud platform 104.

Block 304 recites managing, by the socket control plane, the tunnel connection between the cloud platform, the computing device, and each of the one or more scanners using the WebSocket.

In some examples, the socket control plane manages the tunnel connection between the cloud platform, the computing device, and each of the one or more scanners, by performing one or more actions. For example, the socket control plane, such as socket control servers 114 may be configured to authenticate the tunnel connection generated between the computing device and the cloud platform via the WebSocket. In some examples, socket control servers 114, may authenticate the tunnel connection using one or more authentication and/or verification methods and/or policies, such as authenticate and verify 130 of FIG. 1. In some examples, the socket control plane, such as socket control servers 114 of FIG. 1, is further configured to maintain security of the tunnel connection generated between the computing device and the cloud platform via the WebSocket. In some examples, socket control servers 114 may monitor (e.g., continuously monitor) the generated communications tunnel between computing device 110 and cloud platform 104 to ensure a continuous, secure connection between any one of scanners 112A-112N and cloud platform 104. Socket control servers 114 perform the monitoring via the WebSocket, via long polling protocols, via any other suitable protocol and/or connection, or combinations thereof.

In some examples, socket control servers 114 may be configured to maintain a bidirectional tunnel (e.g., the generated communications tunnel) between the computing node 110 and cloud platform 104. In some examples, in maintaining the generated communication tunnel, socket control servers 114 may further be configured to perform one or more health checks, including regular health checks, on the generated communications tunnel. In some examples, such health checks may be performed, e.g., by socket control servers 114, using one or more applicable techniques, such as a ping-pong technique to ensure the generated tunnel connection remains active and/or stable. In some examples, socket control servers 114 may be configured to be responsible for authenticating the connection and/or maintaining security (e.g., robust security) throughout the communication process between the computing device 110, one or more of scanners 112A-112N, and/or cloud platform 104.

Block 306 recites remotely controlling, by the command control plane, each of the one or more scanners using the WebSocket and from the cloud platform. As described herein, computing device 110 transmits, via the WebSocket (and/or other applicable protocol(s)) metrics regarding one or more of scanners 112A-112N. In some examples, the metrics may comprise a scanner capability information. In some examples, the metrics may comprise scanner operational information. In some examples, the metrics may comprise a combination of both the scanner capability information and/or the scanner operational information. In some examples, the metrics may enable remote control of one or more of scanners 112A-112N by command control servers 116 of cloud platform 104.

In some examples, command control servers 116 may be configured to control one or more of scanners 112A-112N through the socket control servers 114. In controlling one or more of scanners 112A-112N, command control servers 116 may be configured to send one or more directives to one or more of scanners 112A-112N. In some examples, these directives may enable remote initiation of one or more of scanners 112A-112N. In some examples, these directives may enable remote configuration of one or more of scanners 112A-112N. In some examples, these directives may enable remote management for one or more scanning sessions (or other scanner functionality) of one or more of scanners 112A-112N.

As described herein, managing multiple scanners and large scanning jobs, especially in enterprise settings with multiple scanner types and numerous concurrent scanning job requests, can be quite challenging due to the need for efficient coordination and prioritization. In controlling one or more of scanners 112A-112N, command control servers 116 may be configured to apply one or more rules (e.g., one or more predefined rules) to ensure that incoming commands (e.g., from computing device 110 and/or from one or more of scanners 112A-112N) are queued or rejected based on one or more policies. In some examples, the policies may include a scanner load policy. In some examples, the policies may include a network capacity policy. In some examples, the policies may include a workflow priorities policy. In some examples, the policies may include a combination of a scanner load policy, a network capacity policy, and/or a workflow priorities policy. Advantageously, and as described herein, such operations by cloud platform 104 and/or command control servers 116, including use of the one or more policies, may allow for the dynamic allocation of scanning tasks by directing requests to the next available scanner when required. In some examples, such advantages provide for the optimization of large-scale scanning operations and reducing bottlenecks that traditional systems and methods suffer from.

In this way, systems and methods described herein provide for the integration and remote control of scanners (e.g., network-connected scanners) and/or other applicable network-connected computing devices.

Turning now to FIG. 4, FIG. 4 is a flowchart of method 400 for generating and training AI models, arranged in accordance with examples described herein.

The method 400 includes transmitting, by the computing device, data from one of the one or more scanners to the command control plane of the cloud platform using the communication tunnel via the WebSocket in block 402, extracting, by the command control plane, information from the data in block 404, securely storing, by the command control plane, the information in a database of the one or more databases in block 406, transmitting, by the command control plane, the information to the artificial intelligence plane in block 408, analyzing, by the artificial intelligence plane and based on receiving the information from the command control plane, the information to perform one or more operations on the information, the one or more operations comprising classification, grouping, summary generation, report generation, text generation, query answering, artificial intelligence model creation, or combinations thereof in block 410, and, generating and training, by the artificial intelligence plane, an artificial intelligence model based on the information transmitted by the command control plane, wherein the trained artificial intelligence model is configured to analyze subsequent information received from the command control plane via the computing device using the communication channel via the WebSocket in block 412.

Block 402 recites transmitting, by the computing device, data from one of the one or more scanners to the command control plane of the cloud platform using the communication tunnel via the WebSocket.

In some examples, data transmitted from the one or more scanners 112A-112N and to cloud platform 104, via computing device 110, may be scan data as illustrated in FIG. 2. In some examples, scan data may include one or more types of data, such as text data, t data, image data, color data, metadata, and/or any combination thereof. In some examples, text data may comprise information related to any written or printed text on the document, which can be processed using Optical Character Recognition (OCR) to convert it into editable digital text. In some examples, layout data may comprise information relating to the arrangement of text, images, and other elements on the page, which may be important for preserving the original formatting of the scanned document. In some examples, image data may comprise information related to scanned images, such as photographs, graphics, or illustrations, captured in formats like JPEG, PNG, TIFF, or the like. In some examples, color data may comprise information related to the colors in the scanned document, which may be important for accurate reproduction of images and graphics. In some examples, metadata data may comprise information related to information about the scan itself, such as the date and time of the scan, resolution settings, file format, and/or other applicable information.

Block 404 recites extracting, by the command control plane, information from the data.

In some examples, command control servers 116 may be configured to extract the information from the data (e.g., the received scan data as illustrated in FIG. 2) using one or more steps, such as a pre-processing step, a text recognition step, a data structuring step, and/or a post-processing step. In some examples, command control servers 116 may be configured to perform a pre-processing operation to enhance the quality of the scan data, where the pre-processing includes one or more of a noise reduction operation, a de-skewing operation (e.g., correcting any tilt), and/or brightness and/or contrast adjustment operation. In some examples, command control servers 116 may be configured to perform a text recognition operation in which OCR software (or the like) analyzes the scan data to identify and recognize text characters. In some examples, pattern recognition algorithms may be used to convert visual text into machine-readable text. In some examples, command control servers 116 may be configured to perform a data structuring step in which the recognized text from the scan data is structured into a readable format. In some examples, this operation may include converting text into editable formats, such as, for example, WORD® or EXCEL®, and/or extracting tables, key-value pairs, and other structured data. In some examples, command control servers 116 may be configured to perform a post-processing operation in which the extracted data may be reviewed and corrected for any errors or inaccuracies. In some examples, this step ensures the data is accurate and usable and/or minimizes likelihood of errors and/or inaccuracies.

Block 406 recites securely storing, by the command control plane, the information in a database of the one or more databases.

In some examples, command control servers 116 may be configured to transmit the extracted information from the scan data into one or more locations, such as cloud storage and/or databases, such as databases 120 of FIG. 1.

Block 408 recites transmitting, by the command control plane, the information to the artificial intelligence plane.

In some examples, an artificial intelligence plane such as generative AI servers 118 of FIG. 1 may be configured to perform operations of the extracted information from the scan data stored in the cloud storage and/or one or more databases, such as databases 120. In some examples, generative AI servers 118 may be configured to perform AI-based extraction of the scan data, extracting the data into further text, layouts, and/or structured tables.

In some examples, generative AI servers 118 may be further configured to perform one or more advanced processing operations on the extracted scan data.

Block 410 recites analyzing, by the artificial intelligence plane and based on receiving the information from the command control plane, the information to perform one or more operations on the information, the one or more operations comprising classification, grouping, summary generation, report generation, text generation, query answering, artificial intelligence model creation, or combinations thereof.

For example, generative AI servers 118 may be further configured to perform an auto-classification of documents operation in which generative AI servers 118 may automatically categorize documents based on content. Generative AI servers 118 may be further configured to perform an auto-grouping operation, in which generative AI servers 118 groups similar documents for more efficient handling. Generative AI servers 118 may be further configured to create and/or generate one or more custom AI models.

In some examples, generative AI servers 118 may leverage transformer-based models (or other models) such as GPT®, T5®, and/or BERT® to analyze and generate new text that may be contextually relevant to the scanned content (e.g., to the scan data). In some examples, Generative AI servers 118 may be further configured to utilize sequence-to-sequence models to perform summarizing and/or translating operations on the extracted information (e.g., the extracted scan data). In some examples, this may result in the generation of one or more summaries, reports, text generation, and/or query answering. In some examples, Generative AI servers 118 may be further configured to generate summaries, which are condensed versions of lengthy documents. In some examples, generative AI servers 118 may be further configured to generate reports, which are (automatically) generated reports or interpretations based on the extracted data (e.g., extracted scan data). In some examples, generative AI servers 118 may be further configured to generate text generations, in which net content is produced that reflects a style and/or information of the original documents (e.g., the scan data, the document scanned by one or more of scanners 112A-112N, etc.). In some examples, generative AI servers 118 may be further configured to perform query answering, in which generative AI servers 118 may provide answers to specific queries using the knowledge extracted from the scanned content (e.g., from the scan data, from the extracted scan data, etc.).

Block 412 recites generating and training, by the artificial intelligence plane, an artificial intelligence model based on the information transmitted by the command control plane, wherein the trained artificial intelligence model is configured to analyze subsequent information received from the command control plane via the computing device using the communication channel via the WebSocket.

In some examples, generative AI servers 118 may be configured to train one or more AI/ML models for analysis of scan data (e.g., subsequently received scan data, the originally received scan data, existing data stored in one or more data bases, such as database 120, and or other types of data). In some examples, generative AI servers 118 may be configured to train the one or more AI/ML models using the extracted data from the originally received scan data from computing device 110 and/or one or more of scanners 112A-112N.

In some examples, generative AI servers 118 may be configured to receive subsequent scan data from computing device 110 and/or one or more scanners 112A-112N via the WebSocket. In some examples, generative AI servers 118 may be configured to analyze subsequently received scan data and using the one or more trained AI/ML models, analyze the subsequently received scan data and perform one or more operations on it, including but not limited to auto-classification (e.g., assigning a type ID to the data) and/or auto-grouping, and/or other applicable operations.

In this way, systems and methods described herein provide for the generating and training of AI/ML models for use in the analysis of scan data.

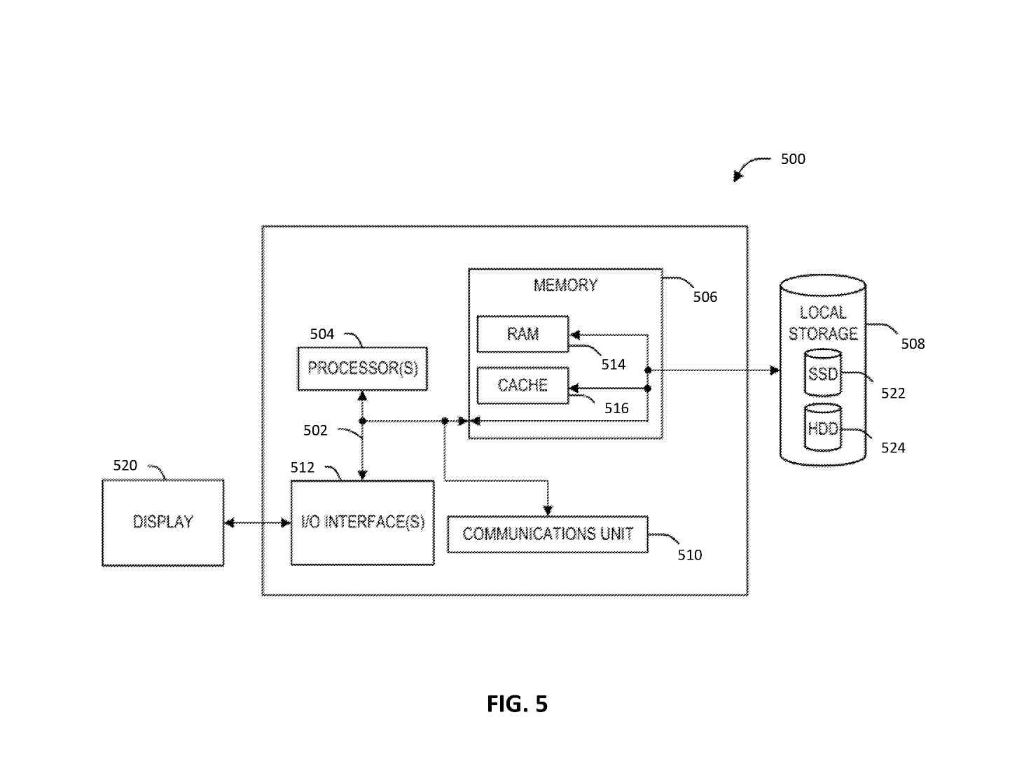

Turning now to FIG. 5, FIG. 5 is a schematic illustration of a computing system in accordance with examples described herein. It should be appreciated that FIG. 5 provides only an illustration of one implementation and does not imply any limitations with regard to the environments in which different embodiments may be implemented. Many modifications to the depicted environment may be made. The computing system may be used to implement and/or may be implemented by one or more components of system 100 of FIG. 1, such as one or more components of enterprise system 102 and/or cloud platform 104, and/or one or more of any of the systems as described herein. The components shown in FIG. 5 are exemplary only, and it is to be understood that additional, fewer, and/or different components may be used in other examples.

The computing system 500 (e.g., a computing device, a computing node, etc.) includes one or more communications fabric(s) 502, which provide communications between one or more processor(s) 504, memory 506, local storage 508, communications unit 510, and/or I/O interface(s) 512. The communications fabric(s) 502 can be implemented with any architecture designed for passing data and/or control information between processors (such as microprocessors, communications and network processors, etc.), system memory, peripheral devices, and any other hardware components within a system. For example, the communications fabric(s) 502 can be implemented with one or more buses.

The memory 506 and the local storage 508 may be computer-readable storage media. In the example of FIG. 5, the memory 506 includes random access memory RAM 514 and cache 516. In general, the memory 506 (and memory as described herein) can include any suitable volatile or non-volatile computer-readable storage media, including non-transitory computer-readable storage media. In this embodiment, the local storage 508 includes an SSD 522 and an HDD 524. The memory 506 may include executable instructions for performing operations described herein.

Various computer instructions, programs, files, images, etc. may be stored in local storage 508 and/or memory 506 for execution by one or more of the respective processor(s) 504 via one or more memories of memory 506. In some examples, local storage 508 includes a magnetic HDD 524. Alternatively, or in addition to a magnetic hard disk drive, local storage 508 can include the SSD 522, a semiconductor storage device, a read-only memory (ROM), an erasable programmable read-only memory (EPROM), a flash memory, or any other computer-readable storage media that is capable of storing program instructions or digital information.

The media used by local storage 508 may also be removable. For example, a removable hard drive may be used for local storage 508. Other examples include optical and magnetic disks, thumb drives, and smart cards that are inserted into a drive for transfer onto another computer-readable storage medium that is also part of local storage 508.

Communications unit 510, in some examples, provides for communications with other data processing systems or devices. For example, communications unit 510 may include one or more network interface cards. Communications unit 510 may provide communications through the use of either or both physical and wireless communications links.

Input/output (I/O) interface(s) 512 may allow for input and output of data with other devices that may be connected to computing system (e.g., device, node, etc.) 500. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks, and memory cards. Software and data used to practice embodiments of the present invention can be stored on such portable computer-readable storage media and can be loaded onto and/or encoded in memory 506 and/or local storage 508 via I/O interface(s) 512 in some examples. I/O interface(s) 512 may connect to a display 520.

Display 520 may provide a mechanism to display data to a user and may be, for example, a computer monitor.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Examples described herein may refer to various components as “coupled” or signals as being “provided to” or “received from” certain components. It is to be understood that in some examples, the components are directly coupled one to another, while in other examples the components are coupled with intervening components disposed between them. Similarly, signal may be provided directly to and/or received directly from the recited components without intervening components, but also may be provided to and/or received from the certain components through intervening components.

From the foregoing it will be appreciated that, although specific embodiments have been described herein for purposes of illustration, various modifications may be made while remaining with the scope of the claimed technology.

What is claimed is:

1. A system for integrating and remotely controlling network-connected scanners, the system comprising:
one or more scanners, each communicatively coupled to a network using one or more network protocols;
a computing device communicatively coupled to the one or more scanners via the network and using the one or more network protocols; and
a cloud platform communicatively coupled to the one or more scanners and the computing device, the cloud platform comprising a socket control plane, a command control plane, an artificial intelligence plane, and one or more databases;
wherein the computing device is configured to, using a scanner-agnostic application programming interface (API), generate a tunnel connection between the cloud platform and the computing device via a WebSocket protocol, the tunnel connection providing communication between the cloud platform and each of the one or more scanners;
wherein the socket control plane is configured to manage the tunnel connection between the cloud platform, the computing device, and each of the one or more scanners using the WebSocket; and
wherein the command control plane is configured to remotely control each of the one or more scanners using the WebSocket and from the cloud platform.

2. The system of claim 1, wherein the computing device is further configured to, using the tunnel connection via the WebSocket, transmit metrics for at least one of the one or more scanners to the cloud platform, the metrics comprising scanner capability information, scanner operational information, or a combination thereof, the metrics enabling remote control of the at least one scanner by the cloud platform.

3. The system of claim 1, wherein the computing device is further configured to, using the scanner-agnostic API, generate the tunnel connection between the cloud platform and the computing device via a long polling protocol.

4. The system of claim 1, wherein the socket control plane is further configured to authenticate the tunnel connection generated between the computing device and the cloud platform via the WebSocket.

5. The system of claim 1, wherein the socket control plane is further configured to maintain security of the tunnel connection generated between the computing device and the cloud platform via the WebSocket.

6. The system of claim 1, wherein the command control plane is further configured to control each of the one or more scanners, including enabling remote initiation, remote configuration, remote management of a scanning session, or combinations thereof, of at least one of the one or more scanners.

7. The system of claim 6, wherein the command control plane controls each of the one or more scanners based on one or more policies, the one or more policies comprising a scanner load policy, a network capacity policy, a workflow priority policy, or combinations thereof, wherein the one or more policies provides for dynamic allocation of scanner resources.

8. The system of claim 1, wherein the computing device is further configured to transmit data from one of the one or more scanners to the command control plane of the cloud platform using the communication tunnel via the WebSocket.

9. The system of claim 8, wherein based on receiving the data from the one of the at least one scanners, the command control plane is further configured to:
extract information from the data;
securely store the information in a database of the one or more databases; and
transmit the information to the artificial intelligence plane.

10. The system of claim 9, wherein based on receiving the information from the command control plane, the artificial intelligence plane is further configured to analyze the information to perform one or more operations on the information, the one or more operations comprising classification, grouping, summary generation, report generation, text generation, query answering, artificial intelligence model creation, or combinations thereof.

11. The system of claim 10, wherein the artificial intelligence plane is further configured to generate and train an artificial intelligence model based on the information transmitted by the command control plane, wherein the trained artificial intelligence model is configured to analyze subsequent information received from the command control plane via the computing device using the communication channel via the WebSocket.

12. The system of claim 1, wherein the artificial intelligence plane is a generative artificial intelligence plane.

13. The system of claim 1, wherein the tunnel generated by the computing device is a secure tunnel, a bidirectional communication tunnel, or a combination thereof.

14. A method comprising:
generating, by a computing device communicatively coupled to one or more scanners via a network, and using a scanner-agnostic application programming interface (API), a tunnel connection between a cloud platform and the computing device via a WebSocket protocol,
wherein the one or more scanners are each communicatively coupled to the network using one or more network protocols,
wherein the cloud platform is communicatively coupled to the one or more scanners and the computing device, and comprises a socket control plane, a command control plane, an artificial intelligence plane, and one or more databases, and
wherein the tunnel connection provides communication between the cloud platform and each of the one or more scanners;
managing, by the socket control plane, the tunnel connection between the cloud platform, the computing device, and each of the one or more scanners using the WebSocket; and
remotely controlling, by the command control plane, each of the one or more scanners using the WebSocket and from the cloud platform.

15. The method of claim 14, the method further comprising transmitting, by the computing device and via the tunnel connection via the WebSocket, metrics for at least one of the one or more scanners to the cloud platform, the metrics comprising scanner capability information, scanner operational information, or a combination thereof, the metrics enabling remote control of the at least one scanner by the cloud platform.

16. The method of claim 14, the method further comprising generating, via the scanner-agnostic API, the tunnel connection between the cloud platform and the computing device via a long polling protocol.

17. The method of claim 14, the method further comprising authenticating, by the socket control plane, the tunnel connection generated between the computing device and the cloud platform via the WebSocket.

18. The method of claim 14, the method further comprising maintaining security, by the socket control plane, of the tunnel connection generated between the computing device and the cloud platform via the WebSocket.

19. The method of claim 14, the method further comprising controlling, by the command control plane, each of the one or more scanners, including enabling remote initiation, remote configuration, remote management of a scanning session, or combinations thereof, of at least one of the one or more scanners.

20. The method of claim 19, wherein the command control plane controls each of the one or more scanners based on one or more policies, the one or more policies comprising a scanner load policy, a network capacity policy, a workflow priority policy, or combinations thereof, wherein the one or more policies provides for dynamic allocation of scanner resources.

21. The method of claim 14, the method further comprising transmitting, by the computing device, data from one of the one or more scanners to the command control plane of the cloud platform using the communication tunnel via the WebSocket.

22. The method of claim 21, wherein, based on receiving the data from the one of the at least one scanners, the method further comprises:
extracting, by the command control plane, information from the data;
securely storing, by the command control plane, the information in a database of the one or more databases; and
transmitting, by the command control plane, the information to the artificial intelligence plane.

23. The method of claim 22, the method further comprising analyzing, by the artificial intelligence plane and based on receiving the information from the command control plane, the information to perform one or more operations on the information, the one or more operations comprising classification, grouping, summary generation, report generation, text generation, query answering, artificial intelligence model creation, or combinations thereof.

24. The method of claim 23, the method further comprising generating and training, by the artificial intelligence plane, an artificial intelligence model based on the information transmitted by the command control plane, wherein the trained artificial intelligence model is configured to analyze subsequent information received from the command control plane via the computing device using the communication channel via the WebSocket.

25. The method of claim 14, wherein the artificial intelligence plane is a generative artificial intelligence plane.

26. The method of claim 14, wherein the tunnel generated by the computing device is a secure tunnel, a bidirectional communication tunnel, or a combination thereof.

27. At least one non-transitory computer-readable storage medium encoded with instructions which, when executed, cause a processor to perform operations comprising:
generating, by a computing device communicatively coupled to one or more scanners via a network, and using a scanner-agnostic application programming interface (API), a tunnel connection between a cloud platform and the computing device via a WebSocket protocol,
wherein the one or more scanners are each communicatively coupled to the network using one or more network protocols,
wherein the cloud platform is communicatively coupled to the one or more scanners and the computing device, and comprises a socket control plane, a command control plane, an artificial intelligence plane, and one or more databases, and
wherein the tunnel connection provides communication between the cloud platform and each of the one or more scanners;
managing, by the socket control plane, the tunnel connection between the cloud platform, the computing device, and each of the one or more scanners using the WebSocket; and
remotely controlling, by the command control plane, each of the one or more scanners using the WebSocket and from the cloud platform.

28. The non-transitory computer-readable storage medium of claim 27, the operations further comprising transmitting, by the computing device and via the tunnel connection via the WebSocket, metrics for at least one of the one or more scanners to the cloud platform, the metrics comprising scanner capability information, scanner operational information, or a combination thereof, the metrics enabling remote control of the at least one scanner by the cloud platform.

29. The non-transitory computer-readable storage medium of claim 27, the operations further comprising generating, via the scanner-agnostic API, the tunnel connection between the cloud platform and the computing device via a long polling protocol.

30. The non-transitory computer-readable storage medium of claim 27, the operations further comprising authenticating, by the socket control plane, the tunnel connection generated between the computing device and the cloud platform via the WebSocket.

31. The non-transitory computer-readable storage medium of claim 27, the operations further comprising maintaining security, by the socket control plane, of the tunnel connection generated between the computing device and the cloud platform via the WebSocket.

32. The non-transitory computer-readable storage medium of claim 27, the operations further comprising controlling, by the command control plane, each of the one or more scanners, including enabling remote initiation, remote configuration, remote management of a scanning session, or combinations thereof, of at least one of the one or more scanners.

33. The non-transitory computer-readable storage medium of claim 32, wherein the command control plane controls each of the one or more scanners based on one or more policies, the one or more policies comprising a scanner load policy, a network capacity policy, a workflow priority policy, or combinations thereof, wherein the one or more policies provides for dynamic allocation of scanner resources.

34. The non-transitory computer-readable storage medium of claim 27, the operations further comprising transmitting, by the computing device, data from one of the one or more scanners to the command control plane of the cloud platform using the communication tunnel via the WebSocket.

35. The non-transitory computer-readable storage medium of claim 34, wherein based on receiving the data from the one of the at least one scanners, the operations further comprising:
extracting, by the command control plane, information from the data;
securely storing, by the command control plane, the information in a database of the one or more databases; and
transmitting, by the command control plane, the information to the artificial intelligence plane.

36. The non-transitory computer-readable storage medium of claim 35, the operations further comprising analyzing, by the artificial intelligence plane and based on receiving the information from the command control plane, the information to perform one or more operations on the information, the one or more operations comprising classification, grouping, summary generation, report generation, text generation, query answering, artificial intelligence model creation, or combinations thereof.

37. The non-transitory computer-readable storage medium of claim 36, the operations further comprising generating and training, by the artificial intelligence plane, an artificial intelligence model based on the information transmitted by the command control plane, wherein the trained artificial intelligence model is configured to analyze subsequent information received from the command control plane via the computing device using the communication channel via the WebSocket.

38. The non-transitory computer-readable storage medium of claim 27, wherein the artificial intelligence plane is a generative artificial intelligence plane.

39. The non-transitory computer-readable storage medium of claim 27, wherein the tunnel generated by the computing device is a secure tunnel, a bidirectional communication tunnel, or a combination thereof.
